(19) United States
(12) Patent Application Publication
(10) Pub. No.: US 2008/0282808 A1
(43) Pub. Date: Nov. 20, 2008

(54) Measuring Means for Measuring a Flow Rate of a Medium Independently of the Medium

(75) Inventors: Hoc Khiem Trieu, Kamp-Lintfort (DE); Thomas Van Den Boom, Duisburg (DE); Dirk Weiler, Herne (DE); Niels Christoffers, Duisburg (DE)

Correspondence Address: SCHOPPE, ZIMMERMAN , STOCKELLER & ZINKLER;C/O KEATING & BENNETT , LLP, 1800 Alexander Bell Drive, SUITE 200, Reston, VA, 20191, US

(73) Assignee: Fraunhofer-Gesellschaft zur Forderung der angewandten Forschung e. V., Munchen (DE)

(21) Appl. No.: 11/996,125

(22) PCT Filed: Jul. 21, 2005
(86) PCT No.: PCT/EP2005/007961

§ 371 Date: Jun. 30, 2008

(51) Int. Cl. G01F 1/66

(52) U.S. Cl. 73/861.27

(57) ABSTRACT

A measurer for measuring a flow rate of a medium which may be multi-component or heterogeneous, independently of the medium, a signal-generating unit generating a transmit signal on the basis of a reference signal of a signal generator and transmitting same by means of a stimulator via the flowing medium. This signal is received by a sensor and passed on to an evaluating unit which is implemented to determine a signal transfer time based on a plurality of mutually corresponding locations of a waveform of the receive signal and the waveform corresponding to the reference signal and the flow rate of the medium based on the signal transfer time and the certain distance between the stimulator and the sensor.

### TECHNICAL FIELD

The present invention relates to measuring means for measuring a flow rate of a medium and, in particular, to measuring a flow rate independently of the medium.

### BACKGROUND

It is hard to imagine our everyday life without microelectronic circuits comprising sensors. They are used in an ever increasing number of most different applications. One class of sensors are flow or stream sensors. The flow rate of a medium, i.e. of a gas or liquid, can be determined using same. When knowing the flow rate, it can for example be controlled as desired. As a result, critical cases in certain applications can be avoided.

The standard methods in flow sensors basically are the pressure gradient method, thermal transport, ultrasound, electromagnetic sensors, Coriolis sensors or mechanical tractive force sensors. Most of these methods can only be applied to a limited extent, the electromagnetic sensors for example necessitate conducting liquids. The most wide spread method is the thermal method which may well be applied in microelectronics.

Typically, two basic elements are used in this method, namely a heating resistor and at least one temperature sensor. In the amplitude method, either the temperature sensor is heated by a constant power and the cooling caused by the flow is measured by means of the temperature sensor or a fixed temperature difference to the environment is set using the temperature sensor and the power necessary for this is detected. In the time-of-flight method, which is also referred to as thermal time-of-flight method, a thermal signal pulse or thermal pulse is provided to the flowing medium using the heating resistor. The temperature sensor detecting the short-term temperature change is located in the flow direction in a certain distance from the heating resistor. The time the thermal pulse necessitates for traveling from the heating resistor to the temperature sensor is a measure of the flow rate of the medium, like for example of a liquid.

FIG. 8 shows a schematic illustration of a conventional scenario for measuring the flow rate of a medium by means of the thermal time-of-flight method. FIG. 8 shows the two essential devices, namely the heating element 10 and the temperature sensor 12 which is arranged in the flow direction 14 in a certain distance x_{flow} 16 to the heating element 10. In the time-of-flight method, what is evaluated of a thermal signal, the thermal pulse, generated by the heating element 10 at a receiver, the temperature sensor 12, is an amplitude of the thermal pulse transmitted. Thus, the amplitude and the heating power Pₕₑₐₜ(t) of the thermal pulse transmitted is controlled by the heating voltage uₕₑₐₜ(t) 18 and the amplitude of the thermal pulse received, in the form of the sensor voltage uₛₑₙₛ(t) 20, is evaluated behind the temperature sensor by means of a comparator which compares the sensor voltage 20 to a reference voltage value. The operating time of the temperature sensor is adjusted by means of the positive and negative supply voltages u_{dd} 12A and uₛₛ 12B.

If the sensor voltage uₛₑₙₛ(t) 20 exceeds the reference voltage value, the comparator will switch through and then exemplarily stop a counter which had started to measure a time in that moment the impulse was provided to the heating element 10. The counter is not illustrated in FIG. 8. The count or the respective time T_{flow} will then be directly dependent on a flow rate v_{flow} of the medium. The following applies for the flow rate of the medium:

v_{flow}=x_{flow}/T_{flow}

In a single-component, i.e. homogenous, medium, the signal amplitude will also still change in dependence on the flow rate, however this change can be pre-calculated and the system be well dimensioned for it. In a single-component and/or homogeneous medium, the material parameters of the medium, such as thermal conductivity, specific capacitance, density and viscosity, remain unchanged. A sensor system calibrated once could thereupon theoretically be applied without interferences for a long time.

Of disadvantage in the known technology described is the considerable amount of faulty measurements in multi-component, i.e. inhomogeneous or heterogeneous, media. Multi-component media may be abrasive, contain different components in different concentrations and with various thermal conductivities and densities, carry along diverse materials, etc. The result is that the thermal pulse emitted by the heating element 10 is altered strongly by the medium, in particular attenuated, and may even no longer be recognizable at the temperature sensor 12, due to a reference signal voltage value calibrated before. In a multi-component medium, the degrees of freedom and potential changes in the signal amplitude caused by different thermal parameters of the media components are that great that secure dimensioning and/or calibration of the comparator are no longer possible. Thus, the conventional method fails. Additionally, non-idealities, such as long-term drift of the reference signal voltage, may disturb permanent operation of the temperature sensor 12 even in single-component or homogeneous media.

### SUMMARY

According to an embodiment, measuring means for measuring a flow rate of a medium may have: a signal-generating unit which has a signal generator implemented to generate a digital reference signal and to generate an analog transmit signal on the basis of the reference signal, a DA converter being provided for generating the analog transmit signal on the basis of the digital reference signal; a stimulator implemented to provide a passing medium with a signal based on the transmit signal; a sensor which is arranged in a certain distance to the stimulator and implemented to receive the signal transmitted by the medium and convert same to an electrical receive signal; and an evaluating unit implemented to receive the digital reference signal or code from which the signal generator generates the digital reference signal, to determine a signal transfer time based on a plurality of mutually corresponding locations of a waveform of a digital version of the receive signal and a waveform corresponding to the digital reference signal and to determine the flow rate based on the signal transfer time and the distance between the stimulator and the sensor, an AD converter being provided for generating the digital version of the receive signal.

According to another embodiment, a method for measuring a flow rate of a medium may have the steps of: generating an analog transmit signal on the basis of a digital reference signal of a signal generator; providing a medium flowing past a stimulator with a signal which is based on the transmit signal, by means of the stimulator; receiving and converting the signal to an electrical receive signal by means of a sensor; receiving the digital reference signal or code from which the digital reference signal has been generated; and evaluating a plurality of mutually corresponding locations of a waveform of a digital version of the receive signal and a waveform corresponding to the digital reference signal to determine the signal transfer time, and determining the flow rate based on the signal transfer time and a certain distance between the sensor and the stimulator.

An embodiment may have a computer program having a program code for executing the above-mentioned method when the computer program runs on a computer.

Embodiments of the present invention are based on the finding that the dependence of a measurement on an amplitude of the signal received can be reduced significantly by evaluating a waveform of a signal received at a sensor, since, in contrast to known technology, not the amplitude of an individual impulse, but different signal components and/or characteristics can be evaluated for the measurement. According to an embodiment of the invention, measuring means is provided which comprises a signal-generating unit implemented to generate a transmit signal on the basis of a reference signal generated by a signal generator, comprises a stimulator implemented to provide a flowing medium with a signal based on the transmit signal, and comprises an evaluating unit implemented to determine, based on a plurality of mutually corresponding locations of a waveform of a receive signal received and transformed by a sensor and a waveform corresponding to the reference signal, a transfer time and thus also a flow rate of the medium.

An embodiment is based on a thermal method in which the stimulator is implemented as a heating element, the signal provided to the medium is implemented as a thermal signal and the sensor is implemented as a temperature sensor.

In contrast to known technology where only the amplitude of a single pulse is evaluated and thus a purely binary threshold value decision is made for a time measurement, inventive measuring means evaluates other signal components, namely the waveform or signal form. Thus, the signal may exemplarily be a sequence of heating impulses or impulses, wherein the heating impulses may be pure rectangular impulses, however, they may also be ones which are particularly suitable or optimized with regard to their shape for this kind of measuring the flow time.

Inventive means may use telecommunication methods of signal evaluation and, particularly advantageously, mobile radio telecommunication methods.

The inventive measuring means suppresses the measurement sensitivity to an amplitude threshold considerably, which is why it is particularly suitable for being employed in multi-component media.

Furthermore, the inventive measuring means also allows making the field of application of, for example, the thermal method in flow sensors more flexible and/or extending same considerably.

An embodiment of the present invention is characterized in that it evaluates, instead of a single impulse, the waveform or signal pattern of the signal generated by a signal generator by means of correlation, wherein advantageously PN (pseudo-noise) codes and/or a PN signal generator are used due to their very good auto-correlation characteristics and, particularly advantageously, maximum detectors and/or synchronization circuits based on a phase-locked loop are used for a very precise time measurement so that the measuring precision exemplarily may be considerably better than half a sample period.

Another embodiment of the present invention evaluates the phase delay and/or group delay by means of a Fourier transform in order to determine the flow rate.

Whereas up to now only thermo-metrical methods could be used in single-component or homogeneous media, inventive measuring means allows measuring the flow rate of multi-component or heterogeneous media. Heterogeneous media may exemplarily be different liquids, wherein these liquids may comprise gases dissolved in a liquid or solid particles carried with it and/or be different gases, which in turn may comprise liquid parts and/or solid particles. Since inventive measuring means evaluates different signal components than the amplitude of a single impulse, namely the waveform of the reference and receive signals, changing the temperature coefficient in the media no longer is an obstacle to using a thermo-anemometer.

Even though embodiments of the invention will be discussed in greater detail below referring to embodiments based on thermo-metrical methods, embodiments of the invention generally speaking describe a mark of the medium flowing past the stimulator so that according to embodiments of the invention, instead of temperature, exemplarily also introducing or changing an electrical charge or suspended material may be used as a mark.

Additionally, the present invention provides an economically interesting way of extending new and existing thermal or other measuring means, i.e. in particular extending the field of usage thereof to measuring flow rates of heterogeneous media.

### BRIEF DESCRIPTION OF THE DRAWINGS

The invention and embodiments of the present invention will be discussed in greater detail below referring to the appended drawings, in which:

FIG. 1 shows a basic block circuit diagram of an inventive embodiment;

FIG. 2 shows a basic block circuit diagram of an embodiment of the present invention which evaluates a temporal sequence of values of a reference signal and a receive signal by means of correlation and/or a matched filter;

FIG. 3 shows a detailed circuit diagram of an inventive embodiment which evaluates the temporal sequence of values of the reference and receive signals by means of correlation and/or a matched filter;

FIGS. 4A-D show waveforms for the embodiment shown in FIG. 3, FIG. 4A showing a waveform of a reference signal at the output of the signal generator, FIG. 4B showing a waveform of a signal at an output of an upsampler, FIG. 4C showing a waveform of a signal after impulse-shaping at an output of a DA converter, and FIG. 4D showing a waveform of a receive signal at an input of an AD converter and/or an output of the transmission channel;

FIGS. 5A-D show waveforms for the embodiment shown in FIG. 3, FIG. 5A again showing the waveform of the receive signal at the input of the AD converter and/or the output of the transmission channel, FIG. 5B showing a waveform of a signal at an output of an impulse matched filter, FIG. 5C showing a waveform of a signal at an output of a magnitude-forming element and/or after rectification for synchronization, and FIG. 5D showing a waveform of the signal at an output of a signal-matched filter;

FIG. 6 shows a schematic representation for illustrating the requirements to the characteristics of a numerical derivation when sampling outside local maximums;

FIG. 7 shows a schematic representation of an embodiment which is implemented to determine the signal transfer time by means of Fourier-transformation of the signals; and

FIG. 8 shows a schematic representation of a conventional scenario for measuring a flow rate of a medium by means of the thermal time-of-flight method.

### DETAILED DESCRIPTION

In the subsequent description of the invention and embodiments, same reference numerals will be used for same elements or elements having the same effect.

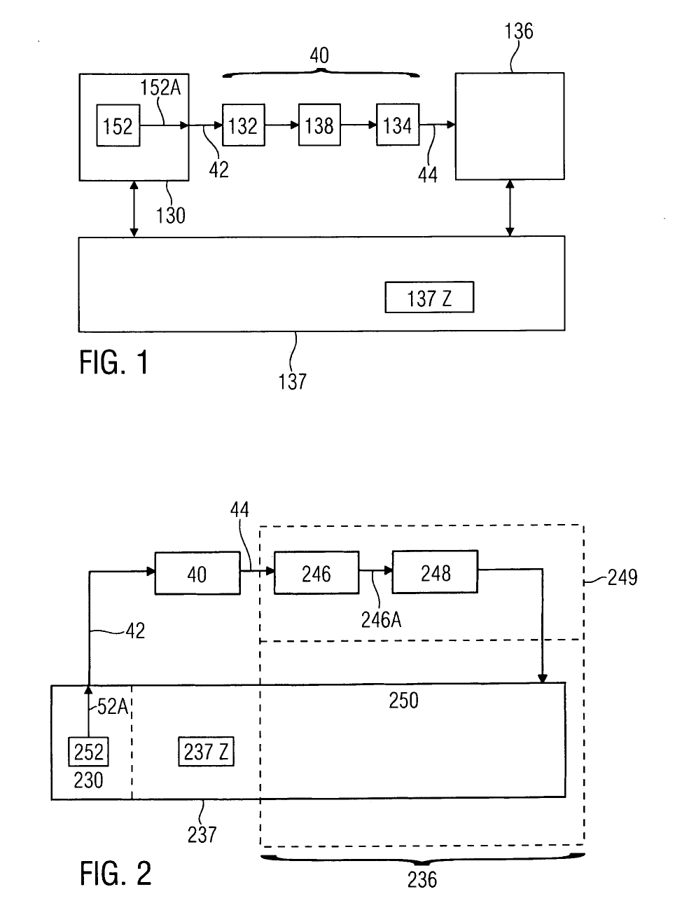

FIG. 1 shows an embodiment of inventive measuring means comprising a signal-generating unit 130 having a signal generator 152, a heating element 132, a temperature sensor 134 and an evaluating unit 136.

The signal-generating unit 130 comprises a signal generator 152 implemented to generate a reference signal 152A, the signal-generating unit being implemented to generate a transmit signal 42 on the basis of the reference signal 152A. Thus, the transmit signal 42 may be the reference signal 152A or a corresponding processed signal and/or a signal rendered and, maybe, optimized for transmission. The heating element 132 is implemented to generate a thermal signal based on the transmit signal 42 and transmit same via a flowing medium 138 to the temperature sensor 134. The temperature sensor 134 is arranged and implemented in a certain distance to the heating element 132 to receive the thermal signal transmitted by the medium and convert same to an electrical receive signal 44. The evaluating unit 136 is implemented to determine, based on a plurality of mutually corresponding locations of a waveform of the receive signal 44 and the waveform corresponding to the reference signal 152A, a signal transfer time and determine, based on the signal transfer time and the distance between the heating element 132 and the temperature sensor 134, the flow rate.

Optionally, an inventive embodiment may comprise a control unit 137 which is, as illustrated in FIG. 1, coupled to the signal-generating unit 130 and/or the signal generator 152 and the evaluating unit 136, and further implemented to provide a common uniform time base 137Z for all units of the measuring means, but in particular for the signal-generating unit 130 and the evaluating unit 136 and/or for determining the signal transfer time and exemplarily control, i.e. for example start and stop, the signal-generating unit 130 and the evaluating unit 136. In particular, the central control of the signal-generating unit 130 and the evaluating unit 136 can of course also be performed by the signal-generating unit 130 or the evaluating unit 136. Also, the evaluating unit 136 and the signal-generating unit 130 may be coupled directly for a common time base or for control.

Thus, the measurements may be performed on the basis of one or a plurality of reference signals 152A. An embodiment may exemplarily use only a fixed reference signal 152A which is hard-programmed into both the signal generator 152 and the evaluating unit 136. Alternatively, a plurality of reference signals 152A may be programmed into the signal generator 152 and the evaluating unit 136. Additionally, a variable database and/or a variable memory which provides the reference signals 152A to be used via a corresponding data link to both the signal generator 152 and the evaluating unit 136 may also be used. This memory may exemplarily be integrated into the signal generator 152 and/or the signal-generating unit 130, the control unit 137 or the evaluating unit 136. The only prerequisite for a precise measurement is that the reference signal 152 is transmitted in an untampered form to all units, like for example the evaluating unit 136, i.e. that in contrast to a transmission via the flowing medium 138 no delays or distortions are allowed to occur here.

Although FIG. 1 shows the signal-generating unit 130, the heating element 132, the temperature sensor 134, the control unit 137 and the evaluating unit 136 as separate units, the signal-generating unit 130, the control unit and the evaluating unit 136 may exemplarily be integrated to form a unit. A possible integration, however, has no influence on the functionalities of the units of inventive measuring means.

In the sense of telecommunications, the heating element 132, the flowing medium 138 and the temperature sensor 134 in FIG. 1 and subsequent figures and discussions are treated and/or represented as transmission channel 40 and/or communication channel having an impulse response h(t).

FIG. 2 shows an inventive embodiment implemented to determine the signal transfer time based on a temporal sequence of values of a reference signal 52A and a temporal sequence of values of the receive signal 44 by means of correlating the two temporal sequences of values. FIG. 2 shows an optional control unit 237 which provides a time base 237Z and has the signal-generating unit 230 and, thus, the signal generator 252. An output of the signal-generating unit 230 is coupled to the transmission channel 40, an output of the transmission channel 40 in turn is coupled to a matched filter 246 and an output of the matched filter 246 is coupled to a maximum detector 248, the matched filter 246 and the maximum detector 248 forming a first part 249 of the evaluating unit 246. An output of the maximum detector 248 is additionally connected to a second part 250 of the evaluating unit 236, the second part 250 of the evaluating unit being integrated into the control unit 237, as is the signal-generating unit 230.

The telecommunications model on which the inventive embodiment illustrated in FIG. 2 is based will be discussed in greater detail below, wherein the explanations with regard to generating and evaluating a digital and an analog variation of the reference signal or the receive signal and with regard to the signal-processing stage within the signal-generating unit 230 and the evaluating unit 236 are to be considered to be synonymous, unless an explicit differentiation is made.

Generally, a refined representation of analog and digital signals and waveforms will be dispensed with in the description and the figures for the sake of a more simple clearer illustration.

The signal-generating unit 230 generates a transmit signal on the basis of the reference signal 52A s(t) generated by the signal generator 252 and outputs same via an output. The reference signal s(t) and/or the transmit signal has a signal duration D. This means that, for t>D, s(t)=0 and, additionally, for t<0, s(t)=0, too.

The transmission channel 40 consisting of the heating element, the flowing medium and the temperature sensor is modeled as a pure delay T in FIG. 2, the delay T corresponding to the signal transfer time. The transmission channel 40 is correspondingly described by the impulse response h₁(t) for which the following applies:

h₁(t)=δ(t−T)

The signal s(t−T), i.e. a variation of s(t) offset in time by T, is measured at an output of the transmission channel 40, corresponding to the convolution of the reference signal s(t) and/or the transmit signal with the impulse response h₁(t)=δ(t−T). Additionally, a signal distortion caused by noise is neglected. This is why it is possible to form a signal-matched filter (MF) 246 which generates a maximum signal value at an output as soon as the receive signal s(t−T) is finished, i.e. when s(t−T)=0 again. Thus, a matched filter generally is defined in that it maximizes a signal-to-noise distance in a way tuned best to the transmit signal and/or the transmission channel. In this embodiment, the signal-matched filter 246 effects this on the basis of a correlation which may also be interpreted as convoluting the receive signal with the reference signal 52A and, correspondingly, the signal-matched filter 246 may be interpreted as a matched filter with the impulse response h₂(t)=s(t). Thus, the signal-matched filter 246 is signal-adjusted, i.e. registers delayed variations of the reference signal s(t) 52A as well as possible. Additionally, it suppresses the punch through of other signals u(t), which are no delayed variations of the reference signal s(t) 52A, at its input to its output as well as possible. A different signal u(t) may, for example, be noise.

The time of the local maximum of the output signal of the signal-matched filter 246 be T_{M} and is a measure of the delay T through the transmission channel and/or for the signal transfer time T. What is evaluated is the temporal difference between the time of the local maximum T_{M} and the end of transmitting the reference signal s(t) 52A and/or the transmit signal 42, D. The following results for the signal transfer time:

T=T_{M}−D

The evaluating unit 236 comprises a maximum detector 248 apart from the matched filter 246 in the first part of the evaluating unit 249, and a second part of the evaluating unit 250, the maximum detector 248 being implemented to generate exemplarily an impulse at the time of a local maximum of the signal 46A at the output of the signal-matched filter 246. Thus, the maximum detector 248 exemplarily outputs an impulse at the time T_{M} in a manner controlled by the matched filter 246, the impulse being registered and processed at an input of the second part of the evaluating unit 250. The second part of the evaluating unit 250 in this embodiment is implemented to perform the time measurement, wherein evaluating the signal transmission time may exemplarily then take place according to a stop watch principle in that the second part of the evaluating unit 250 starts measuring a time at the time D of the end of the reference signal s(t) 52A and stops again at the time of the impulse T_{M}. Thus, the control unit may exemplarily provide the time base 237Z for the time measurement. Alternatively, the function of the time measurement may also exemplarily be integrated in separate time measuring means or another functional block, such as, for example, the signal-generating unit 230.

When realizing the measuring means of FIG. 2, it is of advantage to take a number of deviations between the model employed there and discussed before and reality into consideration.

A deviation is the fact that the transmission channel 40 does not represent a pure delay. h₁(t) consequently is unequal to δ(t−T), so that the reference signal s(t) 52A and/or the transmit signal 42 is slurred and/or distorted by the transmission channel 40. Nevertheless, h₁(t) describes a delay of some kind.

Inventive embodiments thus comprise impulse-shaping tuned to the transmission channel 40 which provides for the signal waveform of the reference signal s(t) 52A and thus the waveform of the reference signal 52A and/or the transmit signal 42 to be maintained as well as possible when transmitting via the transmission channel 40.

Another deviation between the real system and the model is that all signals are superimposed by noise, i.e. there is also little noise at the output of a matched filter. For the most precise measurement of the signal transfer time possible, the instance of the local maximum in the signal 246A at the output of the signal matched filter 246 has to be as high as possible.

So-called PN (pseudo-noise) codes which are also referred to as PN signals, PN sequences or pseudo-random sequences, generate particularly marked local maximums in the signals at the outputs of their matched filters. An inventive embodiment thus comprises a PN code as reference signal 52A. However, other reference signals approximating the advantageous characteristics of the PN codes may also be used. The marked local maximum of the PN codes at the output of the signal-matched filter 246 can be attributed to its good so-called auto-correlation characteristics. Put differently, a signal having good auto-correlation characteristics may also be considered to be one which, with auto-correlation, generates a defined recognizable maximum and/or a defined recognizable maximum at the output of a matched filter.

The easiest way of generating binary PN codes is an n-staged feedback shift register. The output signals of several shift register stages here are subjected to a modulo-2 addition and fed back to the input. The PN code and/or PN sequence generated in this way will periodically repeat itself at the latest when the shift register has passed all possible states. The PN code thus is periodical having a maximum signal and/or sequence length of N=2ⁿ−1. However, the maximum signal length will only be reached when specific stages of the shift register are fed back. A PN code and/or its waveform is defined by the length n of the shift register, the type of feedback and the starting occupancy of the shift register.

Another deviation is that the noise influences the signal transfer time measured, i.e. the signal transfer time in the real system is faulty. Additionally, changes in the signal transfer times have to be traced, which in turn necessitates repeating determining the signal transfer times and averaging the signal transfer times.

An inventive embodiment is implemented to not only transmit a single reference signal s(t) 52A and/or a transmit signal 42 based thereon, but to transmit several reference signals sᵢ(t) 52A which are easily distinguishable but of equal length and corresponding transmit signals 42 thereof. A reference signal sᵢ(t) 52A and/or a signal sequence and the transmit signal 42 based thereon must be easily distinguishable from another reference signal sᵢ(t) 52A and/or the corresponding transmit signal 42 thereof in order to be able to unambiguously associate the impulses at the output of the maximum detector 248 to certain reference signals sᵢ(t) 52A and thus exemplarily to starting times of a stop watch. The reference signals sᵢ(t) 52A and/or signal sequences may have the same length in order for a periodic sequence to form at the output of the maximum detector 48. In this case, the necessary averaging of the signal transfer times may exemplarily be performed by means of the low-pass effect of a phase-locked loop.

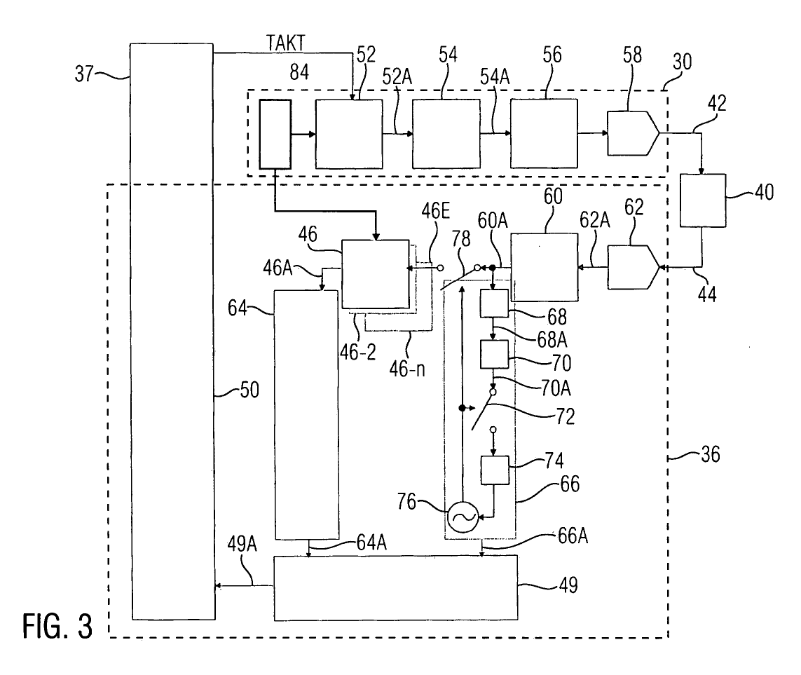

FIG. 3 shows the circuit diagram of a potential realization of the inventive embodiment described in FIG. 2. FIG. 3 shows a signal-generating unit 30, an evaluating unit 36 and the transmission channel 40 which includes the heating element, the temperature sensor and the flowing medium which, however, are not shown separately in FIG. 3. The signal-generating unit 30 comprises a signal generator 52, an upsampling unit 54, an impulse-shaping unit 56 and a DA (digital-analog) converter 58. The signal generator 52 generates a digital reference signal 52A and/or a signal sequence having a sequence length of N bits which is converted by the DA converter 58 to an analog transmit signal 42 for being transmitted via the transmission channel 40. In order to allow the signal transfer time to be determined in the best way possible, the digital signal generator 52 may be implemented to generate reference signals 52A of the best auto-correlation characteristics possible. PN codes comprise particularly good auto-correlation characteristics. Thus, a particularly advantageous inventive embodiment comprises a PN signal generator generating PN codes of, in particular, a signal length of 63 or 255 bits.

Impulse-shaping may be performed optionally for a better adjustment of the transmit signal 42 to be transmitted to the transmission channel 40. Impulse-shaping by means of the impulse-shaping unit 56 forces upsampling, the signal values additionally inserted by upsampling in this embodiment all comprising a zero value, which is why this is also referred to as zero insertion. Clocking by means of zero insertion is effected by the upsampling unit 54. When k defines the upsampling ratio between a clock frequency or clock rate f_{52A} of the reference signal 52A at the output of the signal generator 52 and f_{54A} defines a clock frequency of a signal 54 at the output of the upsampling unit 54, f_{52A}=k*f_{54A} and/or Δt_{54A}=1/k*Δt_{52A} for the corresponding clock durations Δt₅₂ and Δt₅₄ when transmitting applies. Advantageous upsampling ratios k are in the range from 2 to 8. Furthermore, in the case of impulse-shaping, an impulse matched filter 60 tuned to the impulse-shaping unit 56 is necessary in the evaluating unit 36.

Alternatively, inventive embodiments may also comprise other realizations of impulse-shaping or upsampling.

Of course, an inventive embodiment of the signal-generating unit 30 may also comprise an analog signal generator 52 generating an analog reference signal 52A. In this case, no DA converter 58 is necessary and only an AD (analog-digital) conversion of the analog reference signal 52A is to be provided exemplarily for possible digital evaluation. Irrespective of whether the signal generator 52 is implemented as an analog or digital signal generator 52, a signal-generating unit 30 is implemented to generate a reference signal 52A and/or a transmit signal 42 based thereon having more than one local extreme value.

In an inventive embodiment where the evaluating unit 36 determines the signal transfer time based on a digital version of the receive signal 44 and a digital version of the reference signal 52A, the evaluating unit 36 has an AD converter 62 at a signal input.

An inventive embodiment which determines the signal transfer time by means of a PN signal and auto-correlation of the digital version of the reference signal and the digital version of the receive signal will be discussed below. Inventive measuring means in this case basically includes a PN signal generator 52 generating the reference signal 52A having a sequence length N and the respective signal matched filter 46. Using the digital signal generator 52 and/or PN signal generator 52 has the great advantage that the digital version of the reference signal 52A is known and does not have to be obtained for digital evaluation by means of an AD conversion. Since both signal generation and matched filtering are performed digitally, as described before, a DA converter 58 and an AD converter 62 are necessary. Additionally, the inventive embodiment comprises an upsampling unit 54, an impulse-shaping unit 56 and correspondingly an impulse-matched filter 60 tuned to the impulse-shaping unit 56 which is coupled to an output of the AD converter 62. As maximum detectors, the evaluating unit 36 comprises a signal-synchronizing circuit 64 at an output of the signal-matched filter 46 and an impulse-synchronizing circuit 66 at an output of the impulse-matched filter 60. The synchronization circuits 64, 66, like the maximum detectors described before, serve for detecting a time of a local maximum. This is also referred to as maximum detection. The maximum detection and/or determination of the signal transfer time in this way takes place in two stages.

The position of the magnitude maximum on the time axis is a measure of the signal transfer time T_{flow} and thus of the flow rate.

The impulse-synchronizing circuit 66 in this embodiment comprises a magnitude-forming element 68, a differentiating element 70, a first sampler 72, a loop filter 74, a numerically controlled oscillator 76 and a second sampler 78, the numerically controlled oscillator 76 controlling both the first sampler 72 and the second sampler 78.

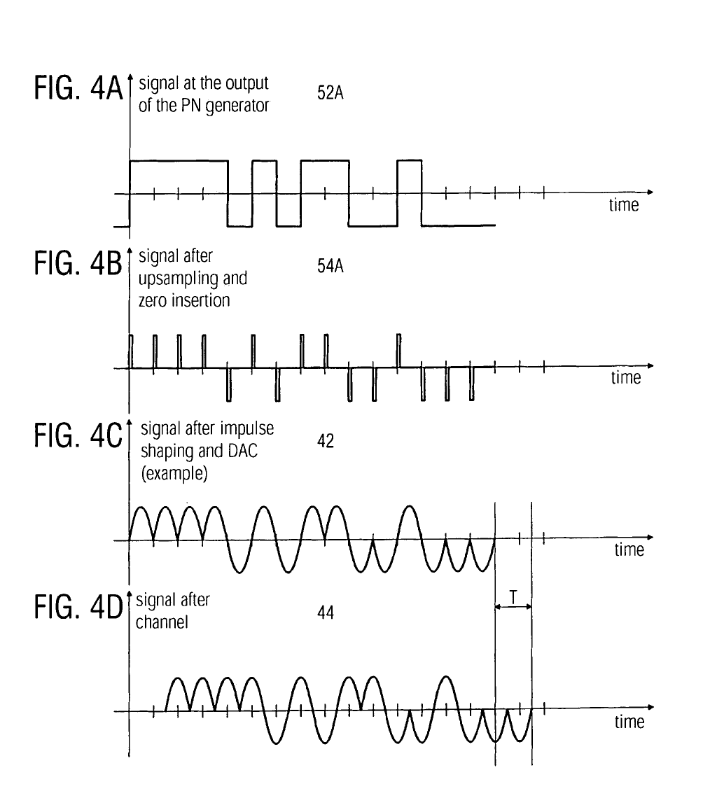

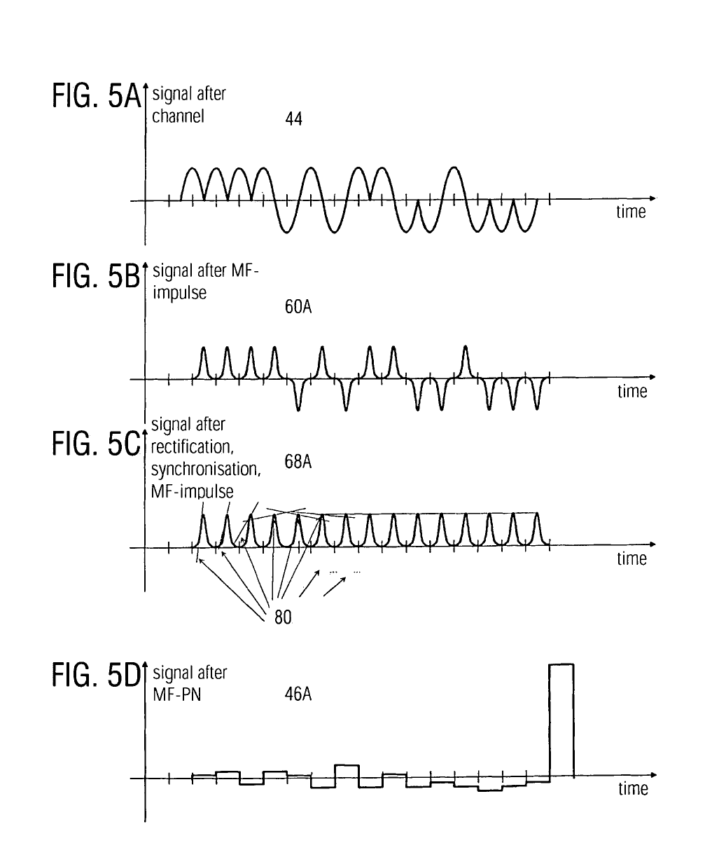

The mode of functioning of the inventive embodiment will be discussed using an exemplary shape of a waveform in FIGS. 4A-4D and FIGS. 5A-5D. What is illustrated is the shape of an individual PN sequence as a reference signal 52A which undergoes impulse shaping and is recognized in the evaluating unit 36 at a delayed time. Thus, FIG. 4A represents a waveform of the reference signal 52A at the output of the PN signal generator 52, FIG. 4B represents a waveform of the signal 54A at the output of the upsampling unit 54 including zero insertion, FIG. 4C represents a waveform of the transmit signal 42 at an output of the DA converter 58, and FIG. 4D represents a waveform of the receive signal 44 at an input of the AD converter 62.

FIG. 5A corresponds to FIG. 4D and represents the waveform of the receive signal 44 at the input of the AD converter 62. FIG. 5B represents a waveform of the signal 60A at an output of the impulse-matched filter 60, FIG. 5C represents a waveform of a signal 68A at an output of the magnitude-forming element 68, and FIG. 5D represents a waveform of a signal 46A at an output of the signal-matched filter 46.

In an implementation, the loop filter (LF) 74 integrates part of an input signal in order for the impulse-synchronizing circuit 66 to provide a correct result. Of course, different embodiments of the impulse-synchronizing circuit 66 may be used, in particular different embodiments on the basis of a phase-locked loop (PLL).

The embodiment of an impulse-synchronizing circuit 66 shown in FIG. 3 is based on a phase-locked loop. It is essential for embodiments of the impulse-synchronizing circuit 66 that they are implemented to recognize a time of a local extreme value of the signal 60A, see FIG. 5B, and/or a local maximum magnitude, see FIG. 5C, and to control sampling of the signal 60A by means of the second sampler 78 such that, after a synchronization phase, the second sampler 78 samples the local extreme values of the signal 60A at the output of the impulse-matched filter 60 for further processing in the signal-matched filter 46, wherein the local extreme values according to FIG. 5B may be both local maximums and local minimums. Thus, an impulse-synchronizing circuit 66 and/or a second sampler 78 causes the reference signal 60A to be sampled such that a signal 46E at an input of the signal-matched filter 46 is synchronized with the signal 52A and a clock frequency f_{46E} and/or a clock duration Δt_{46E} thereof corresponds to the clock frequency f_{52A} and/or the clock duration Δt_{52A} of the transmit signal 52A at the output of the signal generator 52.

In the signal 60A at the output of the impulse-matched filter 60, no local maximums, but local magnitude maximums, i.e. local maximums and local minimums, are searched for impulse and/or clock synchronization, since the impulses generated by the signal-generating unit can be weighted by the factors +1 or −1 in a telecommunications meaning. This is effected by means of the magnitude-forming element 68. This is exemplarily illustrated in FIGS. 5B and 5C. FIG. 5B shows the receive signal 60A with local maximums and local minimums, and FIG. 5C shows the shape of the signal 68A after rectification and/or magnitude forming.

The fact that the relative magnitude maximums occur periodically is made use of. The numerically controlled oscillator (NCO) 76 controls the first sampler 72 and the second sampler 78 which sample simultaneously. The first sampler 72 samples the derivation of the signal 68A at the output of the magnitude-forming element 68, the second sampler 78 samples the signal 60A at the output of the impulse-matched filter 60. An exemplary course of sampling is illustrated in FIG. 5C, wherein the respective times of sampling are indicated by tangents at the rectified signal course indicated there. If the times of sampling are too early, the gradient of the tangents and thus the derivation sampled are possible. The result is that the loop filter 74 shown in FIG. 3 exemplarily gradually increases its output value. This causes the numerically controlled oscillator 76 to oscillate faster and the times of sampling come closer to the magnitude maximums. If the points of sampling are too late, the loop filter 74 will gradually decrease its output value, the numerically controlled oscillator will oscillate slower and the points of sampling again get closer to the maximum magnitudes. A feedback loop is formed by the differentiating element 70, the first sampler 72, the loop filter 74 and the numerically controlled oscillator 76. The loop filter 74 on the one hand provides for stability of this feedback circuit and on the other hand for the averaging necessary as mentioned before. The feedback loop is comparable to a phase-locked loop, wherein a phase detector conventional for a phase-locked loop has been replaced by the differentiating element 70 and the first sampler 72.

A phase-locked loop and, in particular, a phase-locked loop comprising a magnitude-forming element, a differentiating element, a first sampler, a loop filter and a numerically controlled oscillator may be used for the signal-synchronizing circuit 64 like, for example, for the impulse-synchronizing circuit 66. As becomes obvious from the waveform in FIG. 5D determining the local maximum and/or maximum detection after the signal-matched filter 46 by means of the differentiating element 68 becomes somewhat problematic. The matched filter generates square-wave signals which do not have a derivation at any location. Advantageously, the derivation is approximated by determining a difference of the sample values and/or signal 46A at the output of the signal-matched filter 46. On the other hand, even the differences do not show at any location in which direction the sampling times have to be shifted in order to find the maximum. An embodiment easy to realize alternatively comprises a threshold value element which only checks whether the signal 46A at the output of the impulse-matched filter 46 has exceeded a threshold value. Additionally, a different synchronization circuit 66 than one which is based on derivation may be used in the impulse-matched filter 60.

The information from both synchronizing circuits, i.e. the signal-synchronizing circuit or maximum detector 64 and the impulse-synchronizing circuit 66, may be used for precisely determining the transfer time. The embodiment in FIG. 3 here comprises a first evaluating block 49 and a second evaluating block 50, the first evaluating block 49 being coupled to an output 66A of the impulse-synchronizing circuit 66 and an output 64A of the signal-synchronizing circuit 64 to exemplarily directly obtain control values of the numerically controlled oscillators of the two synchronization circuits 66, 64, impulses at the times of local extreme values or maximums in the signals 60A or 46A or simply signals, like for example 46A. The second evaluating block 50 is integrated in the control unit 37 and connected to an output 49A of the first evaluating block 49. Thus, the first evaluating block 49 may be implemented to transmit impulses to the second evaluating block 50 at the times of maximums, wherein the second evaluating block in turn may determine the transfer time based thereon and, based on this, the flow rate.

In FIGS. 4 and 5, it has, for reasons of simplicity, been neglected that all the signals in front of the DA converter 58 and behind the AD converter 62 must be digital, i.e. discrete in time and value. These are sampled signals having a certain sample period and/or clock duration. Sampling the time-discrete signals 60A at the output of the impulse-matched filter 60 by the second sampler 78 controlled by the numerically controlled oscillator 76 in impulse synchronization takes place, as has been described before, by selecting a subset of periodical samples from the samples 60A at the output of the impulse-matched filter 60. The same applies for the signal-synchronizing circuit 64 and/or maximum detection at the output 46A of the signal-matched filter 46.

Generally speaking, an inventive embodiment of the signal-synchronizing circuit 64 is implemented to recognize the time of a local maximum and control sampling of the output signal of the signal-matched filter 46 such that the local maximum for determining the signal transfer time is selected, wherein it is additionally implemented to cause the transfer time to be averaged by means of low-pass action.

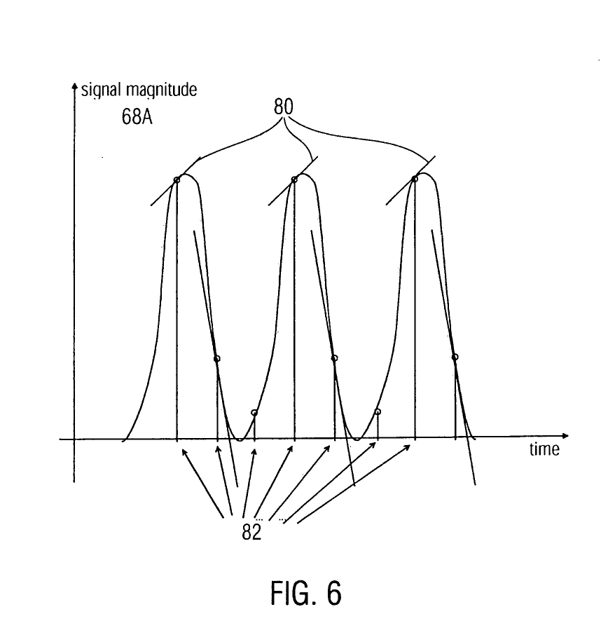

Embodiments of the invention comprise, as described before, synchronization circuits based on phase-locked loops, in particular impulse-synchronizing circuits 66 in order for the precision of measuring a time not to be restricted by a sample period of the signals in front of the DA converter and behind the AD converter. The times of sampling of the first sampler 70 and the second sampler 78 in the impulse-synchronizing circuit 66 after the impulse-matched filter 60 may exemplarily be only the clock times of a time-discrete signal 62A at the output of the AD converter 62 and thus be time-discrete. The time-discrete signal 62A, according to the sampling theory, however, represents a time-continuous signal which in turn corresponds to the output signal of a time-continuous matched filter. The maximum of the time-continuous signal is the best indicator of the flow time, but may be between two sample times of the AD converter. If the sample times were shiftable, maximum detection could be fine-tuned, but they are not, since a sampling pattern is fixed, see FIG. 6. FIG. 6 shows the exemplary course of the signal 68A at the output of the magnitude-forming element 68 and the samples 82 defining the time-discrete signal 68A at the output of the magnitude-forming element 68. Additionally, FIG. 6 shows the tangent 80 of the sample times 82, similarly to FIG. 5C.

The consequence, among other things, is that the derivation to be determined numerically will never equal zero, but vary between slightly positive and slightly negative values. If the differentiating element 70 is exemplarily implemented such that the numerical determination of the derivation at somewhat too early sampling times generates a positive value or positive signal 70A at an output of the differentiating element 70 and, with somewhat too late sampling times, a negative value or negative signal 70A and that the magnitude of the value 70A at the output is the greater the further away the sampling times 82 are from the optimum times, the impulse-synchronizing circuit 66 will nevertheless synchronize to the magnitude maximums of the signal 60A at the output of the impulse-matched filter 60 and this allows implementing an inventive maximum detector.

An exemplary course of synchronization by means of the embodiment of the impulse-synchronizing circuit 66 will be described below. Of the sampling times 82 of the value-discrete receive signal, only some are in direct vicinity to the optimum times and/or the local extreme values of the analog receive signal 44. Some are disposed in front and some behind. When assuming that the early sampling times 82 are closer to the optimum sampling times than the late ones, the control values at an output 74A of the loop filter 74 for the numerically controlled oscillator 76 are, as far as magnitude is concerned, smaller for the early times than for the late ones. In both cases, the numerically controlled oscillator 76 will shift the sample times 80 by a sample period of the AD converter 62 at some time, but in the case of the early samples 82 very much slower, i.e. later, since its control value is, as far as magnitude is concerned, very small. In the case of late sampling times 80, the control value has greater a magnitude and change of the sample times 80 takes place faster, i.e. earlier. Thus, the retention time of positive or negative control values at an output of the numerically controlled oscillator 76 has different durations. With a synchronization based on phase-locked loop, the signal transfer time can be derived with high precision from precisely analyzing the control values of the numerically controlled oscillator 76 and the information obtained there so that the error of the signal transfer time measured is considerably smaller than half a sample period of the AD converter. From the point of view of telecommunications, this highly precise conclusion to the signal transfer times becomes possible since the entire information on the receive signal 44, according to Nyquist criteria, is contained completely in the samples, when the sample rate is selected to be sufficiently high.

Embodiments of the evaluating unit 36, like discussed before, comprise an impulse-synchronizing circuit 66, but the auto-correlation method may also be employed without an impulse-synchronizing circuit 66, however, this may reduce the precision when measuring the signal transfer time, since, depending on the delay and/or phase shift of sampling in front of the signal-matched filter 46 for correlation, not the local extreme values, but values in front of or behind the local value are used. However, this may exemplarily be compensated by increasing sampling and/or upsampling.

Different inventive embodiments of the evaluating means 36 will be mentioned again below in summary. Thus, with regard to the method for determining the signal transfer time, to begin with, two groups of embodiments may exemplarily be differentiated, namely a first group measuring the time only on the basis of maximum detection in the signal 46A at the output of the signal-matched filter 46, and a second group which additionally uses other information of the impulse-synchronizing circuit 66 to determine the signal transfer time.

Inventive embodiments of the first group are implemented to determine the signal transfer time by means of measuring the time and correlating the temporal sequence of values of the transmit signal and the temporal sequence of values of the receive signal. Thus, the maximum detector or signal-synchronizing circuit 64 is implemented to exemplarily recognize the local maximum at the output 46A of the signal-matched filter 46 by means of differentiating, determining the difference or by means of determining the threshold value and to stop measuring the time at the time of recognizing, i.e. with maximum matching of the reference signal waveform and the waveform based on the receive signal. The time measurement is exemplarily performed by the first or second evaluating block 49, 50 which exemplarily receive an impulse 64A when detecting a maximum by the maximum detector or the signal-synchronizing circuit and stop time measurement when receiving the impulse.

The second group of inventive embodiments of the evaluating means 36 is implemented to determine the signal transfer time by means of time measurement, determining the local maximum in the signal 46A at the output of the signal-matched filter 46 and further information of the impulse-synchronizing circuit 66. Thus, this further information of the impulse-synchronizing circuit 66 may exemplarily be one or several control values 74A of the numerically controlled oscillator 76 or a clock impulse so that exemplarily the first or second evaluating block 49, 50 will only stop measuring the time when the output signal of the signal-matched filter 46 has the local maximum and at the same time the impulse-synchronizing circuit 66 recognizes a local extreme value of the receive signal, i.e. exemplarily will only stop measuring the time when the maximum detector and/or the signal-synchronizing circuit 64 and the impulse-synchronizing circuit 66 transmit an impulse 64A, 66A to the first evaluating block 49 at the same time.

Further inventive embodiments of measuring means are characterized by the fact that they comprise a PN code database 84, see FIG. 3, which makes available a plurality of different PN codes 52A as reference signals for signal generation to the PN signal generator 52 and at the same time also for the signal-matched filter 46 for evaluation. The signal-matched filter in FIG. 3 is implemented to determine the correlation for the different PN codes at the same time in further matched filters 46-2 to 46-m connected in parallel. PN codes sᵢ(t) 52A which are best distinguishable among one another may be, as described before, used so that the impulses at the output of the maximum detector and/or the signal-synchronizing circuit 64 can be associated unambiguously to certain PN codes sᵢ(t) 52A and thus starting times for measuring the time, wherein the PN codes sᵢ(t) 52A may additionally have the same length in order for a periodic sequence to form at the output of the maximum detector and/or the signal-synchronizing circuit 64. As described before, in this case the averaging necessary can be performed by the low-pass action of a phase-locked loop.

In summary, an embodiment in signal evaluation looks for a certain known waveform or signal course by means of a signal-matched filter 46. Thus, the waveform or signal course the signal-matched filter 46 looks for may be based on a PN signal or a reference signal comprising similarly good auto-correlation characteristics as PN codes.

The synchronizing circuits 64 and 66 determine the times of the local magnitude maximums. However, they are independent on the amplitudes at the outputs of the matched filters 46 and 60. This is why the signal transfer time determined by the evaluating unit 36 is largely amplitude-independent and thus media-independent, too.

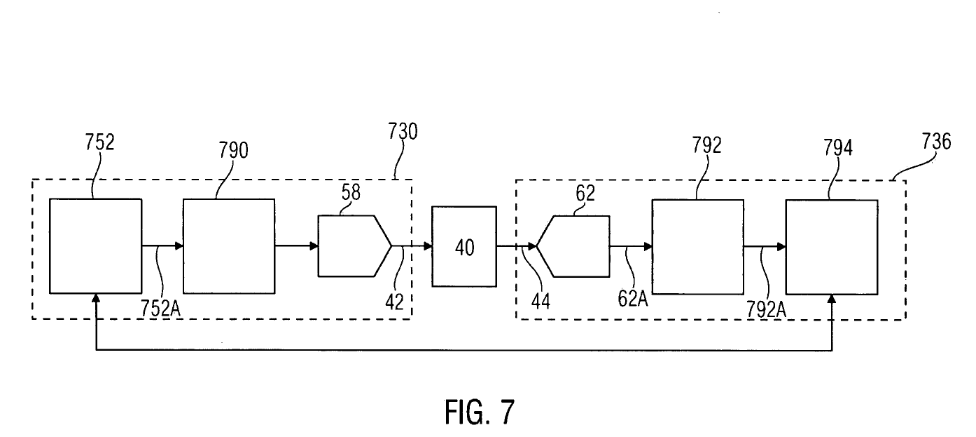

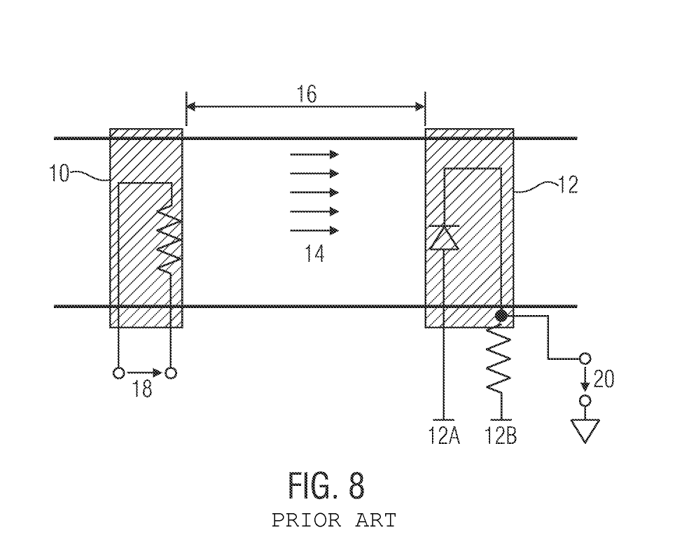

FIG. 7 shows a schematical illustration of an inventive embodiment in which the characteristics of the transmission channel 40 are determined by means of a Fourier transformation. The inventive measuring means comprises the signal-generating unit 730, the evaluating unit 736 and the transmission channel 40, the transmission channel 40 including the heating element, the temperature sensor and the flowing medium which, however, are not represented as separate units in FIG. 7. The characteristics of the transmission channel 40 which is also considered here to be an abstract transmission channel, as described before, are described by the impulse response h(t) and/or the corresponding spectral function in the form of the Fourier transform of the impulse response h(t) which subsequently will be referred to as H(w). In the embodiment according to FIG. 7, the signal-generating unit 730 comprises a signal generator 752, an IFFT (inverse fast Fourier transformation) element 790 and a DA converter 58. The evaluating unit 736 comprises an AD converter 62, an FFT (fast Fourier transformation) element 792 and a phase-extracting unit 794. The AD converter 58 and the DA converter 62 are also necessary here, since the signal generator 752 generates a digital reference signal 752A and the evaluating unit 736 determines the signal transfer time based on a digital version 792A of the receive signal 44 and a digital version of the reference signal 752A and, in particular, the Fourier transform 752A of the transmit signal and/or the Fourier transform 792A of the receive signal 44 and/or digital signal processing is performed. A PN generator 752 may also be used here for the digital signal generator 752, a suitable matched filter not being shown in FIG. 7 since it has no meaning for the function of the measuring means.

The approach for a solution is based on the fact that a transmit signal 42 the Fourier transform 752A of which is known, which will subsequently be referred to as known Fourier transform 752A, is generated by the signal-generating unit 730 at an input of the transmission channel. The known Fourier transform 752A is the output signal of the digital signal generator 752 and/or PN signal generator 752 and the corresponding transmit signal 42 can be generated therefrom by means of the IFFT element 790 and/or the DA converter 58. The Fourier transform 792A of the receive signal 44 at an output of the temperature sensor and/or output of the transmission channel 40, which will subsequently be referred to as received Fourier transform 792A, is determined by the FFT element 792 at the output of the AD converter 62 after the transmission channel 40. When neglecting quantizing errors of the DA converter 58 and the AD converter 62, the Fourier transform of the impulse response h(t) of the transmission channel, referred to as H(w), can be calculated by dividing the received Fourier transform 792A by the known Fourier transform 752A. The Fourier transform H(w) of the impulse response h(t) of the transmission channel 40 contains the information on the signal transfer time T_{flow}. Typically, the phase of H(w) is used and/or extracted for determining the signal transfer time. The derivation of H(w) is calculated for w and the signal transfer time is calculated by a suitable averaging algorithm. If the transmission channel 40 corresponded to a pure delay, the signal transfer time, according to the law of “shifting the time function”, would directly be this derivation which is also referred to as group delay.

An analog signal generator 752 may also be used as an alternative to the digital signal generator 752, the analog transmit signal is exemplarily digitalized only by means of an AD converter and “Fourier transformed” by means of an FFT element and transmitted in parallel to the transmission channel 40 to the phase-extracting unit 794 with as little delay and distortion as possible, the phase-extracting unit 794 performing phase extraction and determining the signal transfer time therefrom. In this embodiment, the phase-extracting unit 794 may be implemented to ensure a common time base and/or starting time where the evaluating unit 736 exemplarily begins forming the Fourier transform 792A of the receive signal 44 and extracting the phase and determining the signal transfer time. Alternatively, a control unit may be provided which is exemplarily coupled to the signal generator 752 and the phase-extracting unit 792 and/or the evaluating unit 736 to provide the time base.

A suitable transmit signal may exemplarily be an OFDM (orthogonal frequency division multiplex) signal, a common data transmission method in, for example, WLAN 802.11a/g which is formed by the IFFT element 90 of a digital transmit signal, like for example a PN signal.

Generally, different inventive measuring means which determine the signal transfer time based on the reference frequency spectrum 752A or a frequency spectrum based on a waveform of a reference signal and the frequency spectrum 792A based on the waveform of the receive signal 44 and are thus amplitude-independent may be used.

In summary, inventive measuring means for measuring a flow rate of a medium by evaluating the waveform of the reference signal and the waveform of the receive signal, in contrast to known technology, is independent on the amplitude of the receive signal 44 and can determine the signal transfer time independently of media and/or is also able to measure flow rates of heterogeneous or multi-component media 38.

Apart from the specific embodiments described before, different methods for determining the delay which are basically independent on the absolute amplitude of the transmission function are also conceivable here.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1-29. (canceled)

30. A measurer for measuring a flow rate of a medium, comprising:
a signal-generating unit which comprises a signal generator implemented to generate a digital reference signal and to generate an analog transmit signal on the basis of the reference signal, a DA converter being provided for generating the analog transmit signal on the basis of the digital reference signal;
a stimulator implemented to provide a passing medium with a signal based on the transmit signal;
a sensor which is arranged in a certain distance to the stimulator and implemented to receive the signal transmitted by the medium and convert same to an electrical receive signal; and
an evaluating unit implemented to receive the digital reference signal or code from which the signal generator generates the digital reference signal, to determine a signal transfer time based on a plurality of mutually corresponding locations of a waveform of a digital version of the receive signal and a waveform corresponding to the digital reference signal and to determine the flow rate based on the signal transfer time and the distance between the stimulator and the sensor, an AD converter being provided for generating the digital version of the receive signal.

31. The measurer according to claim 30, wherein the stimulator is implemented as a heating element, the signal provided to the passing medium being a thermal signal and the sensor being a temperature sensor.

32. The measurer according to claim 30, comprising a control unit for providing a time base for the signal generator and the evaluating unit.

33. The measurer according to claim 30, wherein the waveform of the reference signal and the transmit signal based thereon comprise more than one local extreme value.

34. The measurer according to claim 30, wherein the waveform of the reference signal is one comprising good auto-correlation characteristics and may be a PN (pseudo-noise) code comprising a sequence length of N bits and, more advantageously, a PN code comprising a sequence length of 63 and 255 bits.

35. The measurer according to claim 30, which is implemented to determine the signal transfer time more than once to average the signal transfer time using different reference signals.

36. The measurer according to claim 30, wherein the evaluating unit is implemented to determine the signal transfer time based on a temporal sequence of values of the reference signal and a temporal sequence of values of the receive signal.

37. The measurer according to claim 36, wherein the evaluating unit is implemented to determine the signal transfer time by means of time measurement and correlation of the temporal sequence of values of the reference signal and the temporal sequence of values of the receive signal.

38. The measurer according to claim 37, wherein the evaluating unit comprises a signal-matched filter implemented to compare the temporal sequence of values of the reference signal and the temporal sequence of the receive signal by means of correlation and to generate an output signal which is the greater, the greater the correlation, and to generate a local maximum in the signal at the output of the signal-matched filter at a time of maximum correlation.

39. The measurer according to claim 38, wherein the evaluating unit comprises a maximum detector implemented to recognize the time of a local maximum of the signal at the output of the signal-matched filter and to generate at this time an impulse in a signal at an output of the maximum detector used for the time measurement.

40. The measurer according to claim 39, wherein the maximum detector is implemented to recognize the local maximum by means of differentiating, calculating a difference or calculating a threshold value.

41. The measurer according to claim 39, wherein the maximum detector is formed as a signal-synchronizing circuit implemented to recognize the time of the local maximum of the signals at the output of the signal-matched filter and additionally to control sampling of the signal at the output of the signal-matched filter such that the local maximum is selected, and further implemented to cause averaging of the transfer time by means of low-pass action.

42. The measurer according to claim 38, wherein the evaluating unit comprises an impulse-synchronizing circuit which is connected in front of the signal-matched filter and is implemented to recognize a time of a local extreme value of the receive signal and control sampling of the receive signal such that the local extreme value for a sampled signal at an input of the signal-matched filter is selected after a synchronization phase.

43. The measurer according to claim 42, wherein the impulse-synchronizing circuit is implemented on the basis of a phase-locked loop.

44. The measurer according to claim 43, wherein the impulse-synchronizing circuit based on a phase-locked loop comprises a magnitude-forming element, a differentiating element, a signal sampler controlled by a numerically controlled oscillator, a loop filter controlling the numerically controlled oscillator, and a second sampler also controlled by the numerically controlled oscillator, and may generate impulses used by the evaluating unit and/or exemplarily a first or second evaluating sub-unit of the evaluating unit for measuring the time in the signal at an output of the impulse-synchronizing circuit at the times of the local extreme values.

45. The measurer according to claim 42, which is implemented to determine the signal transfer time by means of measuring the time, recognizing the local maximum in the output signal of the signal-matched filter and further information of the impulse-synchronizing circuit and which can comprise a measuring precision considerably better than half a sample period.

46. The measurer according to claim 45, which is implemented to only stop the time measurement when the maximum detector and/or the signal-synchronizing circuit recognizes the local maximum in the output signal of the signal-matched filter and at the same time the impulse-synchronizing circuit recognizes a local extreme value of the receive signal.

47. The measurer according to claim 30, additionally comprising an upsampling element and an impulse-shaping element, and wherein the evaluator additionally comprises an impulse-matched filter tuned to the impulse-shaping element.

48. The measurer according to claim 30, wherein the evaluating unit is implemented to determine the signal transfer time based on a frequency spectrum of the reference signal and the frequency spectrum of the receive signal.

49. The measurer according to claim 48, wherein the evaluating unit comprises an FFT (fast Fourier transformation) element and a phase-extracting unit, the FFT element forming a Fourier transform of the receive signal, and the phase-extracting unit determining the transfer time by means of phase extraction of the quotient of the Fourier transform of the receive signal and the Fourier transform of the reference signal.

50. The measurer according to claim 48, comprising an IFFT (inverse FFT) element which generates the inverse Fourier transform of the frequency spectrum of the reference signal.

51. A method for measuring a flow rate of a medium, comprising:
generating an analog transmit signal on the basis of a digital reference signal of a signal generator;
providing a medium flowing past a stimulator with a signal which is based on the transmit signal, by means of the stimulator;
receiving and converting the signal to an electrical receive signal by means of a sensor;
receiving the digital reference signal or code from which the digital reference signal has been generated; and
evaluating a plurality of mutually corresponding locations of a waveform of a digital version of the receive signal and a waveform corresponding to the digital reference signal to determine the signal transfer time, and determining the flow rate based on the signal transfer time and a certain distance between the sensor and the stimulator.

52. The method according to claim 51, which is implemented as a thermal method, wherein the signal provided to the passing medium is a thermal signal, wherein providing the thermal signal is caused by means of a heating element, and wherein receiving and converting the thermal signal are caused by means of a temperature sensor.

53. The method according to claim 51, wherein the signal transfer time is determined by means of time measurement and a correlation of a temporal sequence of values of the transmit signal and a temporal sequence of values of the receive signal.

54. The method according to claim 53, wherein the signal transfer time is determined by means of time measurement, correlation and further information of an impulse-synchronizing circuit, advantageously based on a phase-locked loop.

55. The method according to claim 51, wherein the signal transfer time is determined by means of phase extraction from a quotient of a Fourier transform of the reference signal and a Fourier transform of the receive signal.

56. A computer readable medium storing a computer program, when run on a computer, the computer programs executes a method for measuring a flow rate of a medium, comprising:
generating an analog transmit signal on the basis of a digital reference signal of a signal generator;
providing a medium flowing past a stimulator with a signal which is based on the transmit signal, by means of the stimulator; receiving and converting the signal to an electrical receive signal by means of a sensor;
receiving the digital reference signal or code from which the digital reference signal has been generated; and
evaluating a plurality of mutually corresponding locations of a waveform of a digital version of the receive signal and a waveform corresponding to the digital reference signal to determine the signal transfer time, and determining the flow rate based on the signal transfer time and a certain distance between the sensor and the stimulator.
